(19) United States
(12) Patent Application Publication
(10) Pub. No.: US 2007/0114284 A1
(43) Pub. Date: May 24, 2007

(54) Display unit for displaying programmable barcodes

(75) Inventors: Christoph Brabec, Linz (AT); Jens Hauch, Erlangen (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHAFT, Munchen (DE)

(21) Appl. No.: 10/585,082

(22) PCT Filed: Dec. 13, 2004
(86) PCT No.: PCT/EP04/53416

§ 371 Date: Jun. 29, 2006

(30) Foreign Application Priority Data
Dec. 30, 2003 (DE) 103 61 683.7

(51) Int. Cl. G06K 7/10; G06K 19/06

(52) U.S. Cl. 235/462.01; 235/492

(57) ABSTRACT

A programmable display unit for displaying barcodes or, as the case may be, a radio transponder coupled to a programmable display unit of the aforementioned type. The display unit has for the purpose a multiplicity of strip-shaped display elements arranged substantially parallel to and at a predetermined distance from each other. Each strip-shaped display element is controlled independently and can be switched independently. A respectively predetermined number of display elements are used for representing a strip in the barcode. A respectively predetermined number of display elements are analogously used for representing a space in the barcode. The barcode requiring to be represented is composed of a multiplicity of strips and spaces.

The present invention relates to a freely programmable barcode and, in particular, to a display unit advantageously accommodated to the displaying of barcodes.

Barcodes are generally familiar as identification labels for goods, and are widely employed as such. Barcodes have been a common sight particularly since the checkout scanner system was introduced into the retail trade. Barcodes can generally be recognized by a sequence of parallel lines or, as the case may be, bars varying in width and/or spacing. Probably the best known barcodes of said kind are the European Article Number (EAN) code and Universal Product Code (UPC) that were both developed in the nineteen seventies for the labeling of goods specifically in the food sector and have since been in use throughout the retail trade.

The barcode can basically be interpreted as a binary code consisting of a field of bars and spaces arranged in parallel. Depending on the coding or, in this case, symbology used, a predetermined number of bars and spaces are allocated as a pattern element to a predetermined marker or symbol. A barcode sequence can be subdivided into suitable partial sequences by means of a corresponding allocation table, and decoded. The EAN or UPC code is based on, for instance, an allocation table that combines two bars and two spaces, alternating in each case, and assigns the resulting pattern element in each case one of 20 possible symbols, which is to say the numbers 0 to 9 for the left-hand digits having odd parity and the numbers 0 to 9 for the right-hand digits having even parity. It must be mentioned for the sake of completeness that the 20 possible pattern elements or, as the case may be, symbols result from two bars and two spaces that can be 1, 2, or 4 units wide and must in total have a width of 7 units.

Said barcodes are conventionally either printed directly onto products, goods or, as the case may be, packaging, or the products, goods or, as the case may be, their packaging are/is provided with stickers bearing the corresponding barcode. In the optical domain the arrangement of bars and spaces defines a sequence of bright/dark areas that are detected using, for the most part, optical scanners, for example optical laser scanners, then converted into the symbol sequence in keeping with the coding system. For the aforementioned retail goods provided with a barcode based on the EAN code or UPC a data-base is usually available in order subsequently to obtain an allocation between the decoded symbol sequence and goods-related information such as, for example, product name, product category, product price etc.

Irrespective of the chosen symbology, the barcodes are, however, disadvantageously subject to the information density's being limited by a minimum contrast in the bright/dark areas. The total amount of information encoded in a barcode is consequently also restricted since the barcodes are generally constrained in their permissible dimensions. Moreover, barcodes are permanent once having been printed and applied to the specific retail item requiring to be identified, meaning that a new barcode will have to be applied should the need arise to change the information encoded by means of a barcode. Because of the aforementioned disadvantages, radio transponders (referred to also as radio frequency identification transponders, RFID transponders, RFID tags) have been developed that are enjoying growing popularity. Radio transponders are electronic data-storage systems whose stored information can be read out wirelessly. Said radio transponders are advantageously powered by an electromagnetic signal so that the system does not have to be provided with its own power source. Radio transponders are furthermore available whose stored information is reprogrammable. The total amount of stored information is determined substantially only by the technological limits of the memory chips employed. Advances in manufacturing technology, and especially in organic circuitry, have made radio transponders economical to produce, at least setting them on the path toward replacing the barcodes employed hitherto for identifying retail goods. The radio transponders, and rewritable transponders in particular, are suitable for overcoming some of the disadvantages of barcodes.

However, technologically different detection systems are used respectively for detecting barcodes and interrogating transponders so that migrating from one identification system to the other entails a major expenditure.

With reference to the above-discussed disadvantages it is the object of the present invention to provide a programmable barcode that has been accommodated to storing different information for detection by means of a barcode scanner.

A further object of the invention is to provide a programmable barcode that is advantageously coupled to a transponder so that the advantages of both systems are combined while disadvantages due to the combination are avoidable.

One characteristic of the present invention is achieved by means of a barcode that is based on display-unit technology and can be programmed by means of at least one interface so that the information encoded in the barcode can be changed.

A further characteristic of the present invention is an advantageous combining of the barcode based on display-unit technology with a transponder, these being coupled by means of an interface so that the transponder is able to determine the barcode displayed by the display unit.

The present invention is provided by means of independent claims 1 and 9. Advantageous embodiments and developments are defined in the dependent claims.

According to a first characteristic of the invention a programmable display unit is provided for displaying barcodes. Said display unit has for said purpose a multiplicity of strip-shaped display elements arranged substantially parallel to and at a predetermined distance from each other. Each strip-shaped display element is controlled independently and can be switched or, as the case may be, connected independently. A respectively predetermined number of display elements are used for representing a strip in the barcode. A respectively predetermined number of display elements are analogously used for representing a space in the barcode. The barcode requiring to be represented is composed of a multiplicity of strips and spaces.

According to the invention, in each case one group of a predetermined number of strip-shaped display elements are switched in common for each strip in the barcode and, analogously, in each case one group of a predetermined number of strip-shaped display elements are switched in common for each space in the barcode.

The strip-shaped display elements advantageously have at least two switchable statuses. In each case one of said statuses is provided for representing a strip or, as the case may be, space.

The display unit is preferably a meta-stable display unit embodied in particular as an electrochromic or electrophoretic display unit.

According to one embodiment of the invention electronic control circuitry is provided for controlling the strip-shaped display elements. Said electronic control circuitry contains at least one interface accommodated to receiving signals so that a barcode is imaged on the display unit. The electronic control circuitry is advantageously based on organic or, as the case may be, polymeric circuits. The display unit can furthermore be advantageously coupled to a radio transponder (500).

According to a further characteristic of the invention a radio transponder having a display unit for displaying barcodes is provided. Said radio transponder is coupled to the display unit for imaging the barcodes. The display unit has for said purpose a multiplicity of strip-shaped display elements arranged substantially parallel to and at a predetermined distance from each other. Each strip-shaped display element is controlled independently and can be switched independently. An in each case predetermined number of display elements are used for representing a strip in the barcode. An in each case predetermined number of display elements are analogously used for representing a space in the barcode. The barcode requiring to be represented is composed of a multiplicity of strips and spaces.

According to one embodiment of the invention the radio transponder has a display unit of the kind described above.

Specifics and preferred embodiments of the subject of the invention will emerge from the dependent claims as well as from the drawings with the aid of which exemplary embodiments are explained in detail below so said the subject of the invention will become clearly apparent.

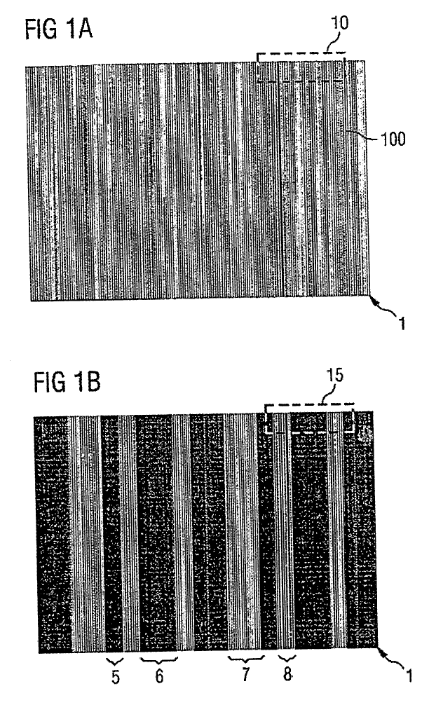

FIG. 1a is a schematic of an inventive display unit for displaying a bar code;

FIG. 1b is a schematic of an inventive display unit according to FIG. 1a with imaging of a barcode representation;

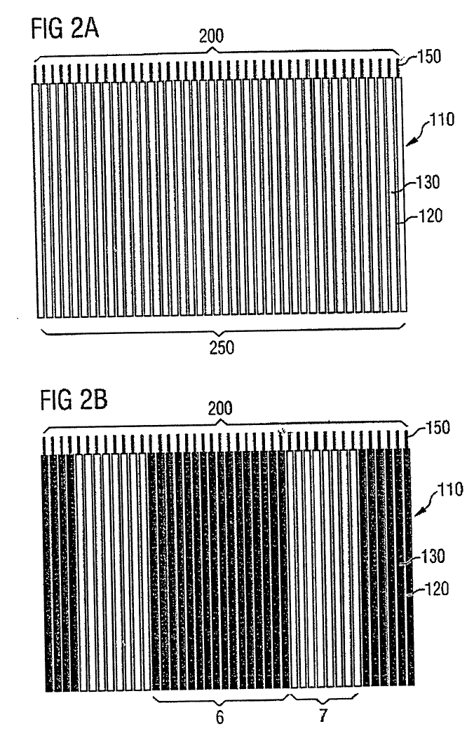

FIG. 2a is a schematic of an enlarged section of the inventive display unit for displaying a bar code according to FIG. 1a;

FIG. 2b is a schematic of an enlarged section of the display unit according to FIG. 1b with imaging of a barcode representation; and

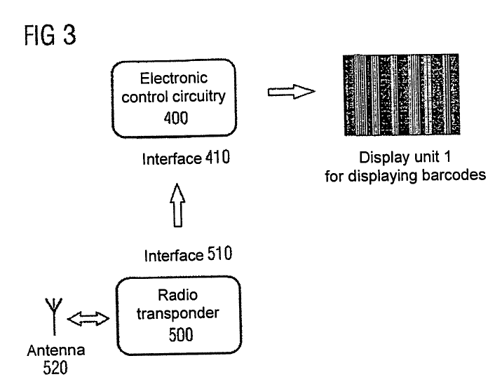

FIG. 3 is a schematic of a control of an inventive display unit for displaying barcodes.

Similar and identical parts, elements, components etc. shown in the Figures are identified by the same reference numerals.

FIG. 1a and FIG. 1b are a view of an inventive display unit for displaying a barcode. FIG. 1a shows a display unit 1, in particular a section of a display unit 1, that is suitable for representing barcodes. The display unit 1 preferably presents a strip-shaped imaging structure advantageously accommodated to the imaging of 1-dimensional barcodes such as, for example, the EAN-encoded or, as the case may be, UPC-encoded barcodes mentioned in the introduction. These are composed by definition of strips and strip-shaped spaces whose spacing and width variations enable encoding. The indicated strip-shaped structuring of the display unit is sufficient for representing 1-dimensional barcodes, the generally customary pixel-based structure of display units not being required therefor.

With reference to FIG. 1b, a section of a barcode is shown by way of example that is imaged in a section of a display unit 1. As mentioned above, the barcode is formed from a strip-shaped imaging structure of which, by way of example, a narrow strip is identified by the numeral 5, a wide strip is identified by the numeral 6, a narrow space is identified by the numeral 8, and a wide space is identified by the numeral 7. It should be noted that the arrangement or, as the case may be, dimensions shown is/are purely illustrative and that the present invention is in no way whatever restricted thereto.

It may be assumed in keeping with the use and area of application of barcodes that a barcode requiring to be displayed on the display unit will be displayed for an exceedingly long period of time, which is to say exceedingly long compared to the display intervals in the microsecond range otherwise targeted within the area of display units. Rather it is the case that barcodes will be displayed within a range of minutes, hours, or days, which is to say for longer by orders of magnitude than is customary for display-unit refresh rates. Meta-stable display units can accordingly be used for the above-targeted purpose. Meta-stable display units are characterized either by having no image refreshing, and accordingly no refresh cycles, or at least by having a long latency for their displays so that few refresh cycles are needed. Display refreshing being an energy-consuming process, the meta-stable display units are consequently energy-saving. The slow display speed of changes in imaging on a meta-stable display unit usually cited as disadvantageous does not disadvantage the present invention because the barcodes requiring to be imaged using the display unit are constant in nature and of long duration. In particular meta-stable low-cost display units able additionally to be embodied preferably as being flexible are also of interest. The preferably flexible meta-stable low-cost display unit having low energy consumption can be controlled via a suitably accommodated interface. The meta-stable display unit can furthermore be embodied as an electrochromic or electrophoretic display unit.

FIG. 2a and FIG. 2b show enlarged sections of the display unit 1 shown in FIG. 1a or, as the case may be, FIG. 1b in order to illustrate the display unit's advantageous structure in detail. The selected sections are identified in FIGS. 1a and 1b respectively as the area 10 and 15.

The inventive display unit's advantageous strip-shaped structure 100 can be seen in FIG. 2a. Said strip-shaped structure 100 is composed of a multiplicity 250 of individual strip-shaped display elements 110, 130 arranged parallel to each other and spaced apart preferably substantially equidistantly at a predetermined distance. The area 120 defined by said distance between two strip-shaped display elements 110, 130 can also be designated as spacers 120. The strip-shaped display elements 110, 130 can be individually switched by means of a control terminal 150. The control terminals 150 can in their totality be designated as a display interface 200.

Switching of a strip-shaped display element 110, 130 is to be understood as the strip-shaped display element's ability to assume substantially two statuses mutually distinguished substantially in terms of their contrast so that two strip-shaped display elements each having a different status are detectably distinguished from each other. Advantageous contrasting is offered through strip-shaped display elements 110, 130 that can be switched to bright or, as the case may be, dark, as can be seen in, for example, the black/white representation shown in FIG. 1b or, as the case may be, FIG. 2b. The invention is not, though, restricted thereto.

An enlarged section of barcode imaging on the display unit 1 shown in FIG. 1b, section 15, can be seen in FIG. 2b. Preferably one multiplicity in each case of individual strip-shaped display elements are switched jointly in order to produce a strip 6 or, as the case may be, a space 7 consisting of strips for barcode imaging. The wide strip 6 is accordingly, by way of illustration, produced by means of joint switching into a same first switching status of 16 individual strip-shaped display elements 110, 130, while the space 7 is produced by means of joint switching into a same second switching status of 8 individual strip-shaped display elements 110, 130, with said first and second switching statuses mutually differing so that a corresponding contrast is discernible between the strip 6 and the space 7. The desired width of strips or, as the case may be, spaces can be set by selecting a predetermined number of strip-shaped display elements 110, 130. Thus the strip 6 shown in FIG. 2b is a wide strip produced by means of 16 jointly switched display elements 110, 130, while the space 7 shown in FIG. 2b corresponds to a narrow space produced by means of 8 jointly switched display elements 110, 130. Further widths of the strips or, as the case may be, space elements can be arranged by means of predefined numbers of display elements 110, 130 to be switched jointly. The non-switchable areas 120, designated also as spacers 120, between the display elements are for said purpose embodied such as not to significantly influence the overall contrast produced by the joint switching of a predetermined number of display elements 110, 130 so that, considering the barcode overall imaged on the display unit 1, the interruptions in the imaging structure due to the spacers 120 will be of no significance, which is to say will not disrupt detecting of the barcode by an optical detection means such as, for example, a laser scanner.

FIG. 3 shows an embodiment of a control of the inventive display unit of the kind discussed above. The component schematic in FIG. 3 shows electronic control circuitry 400 that is assigned to the display unit 1 and can be coupled to the control terminals 150 or, as the case may be, the display interface 200. The electronic control circuitry 400 serves to control or, as the case may be, switch the individual display elements 110, 130 in order to image barcodes by means of the display unit 1 using the above-described method. Said electronic control circuitry 400 has for said purpose been accommodated to the characteristics of the display unit 1, which is to say the electronic control circuitry 400 can contain a memory in which are stored the switching statuses of the display elements 110, 130 in order to enable possibly necessary refreshing of the display unit. The electronic control circuitry serves in particular to [part missing] and can furthermore contain a power supply for the display unit 1 and in particular provide an interface 410 by means of which the barcode requiring to be displayed can be transmitted to the display unit 1.

The illustrated embodiment further includes a radio transponder 500 (or, as the case may be, an RFID transponder) equipped with a readable memory. A programmable radio transponder 500 having a both readable and writable memory is preferably employed therefor. Said radio transponder 500 communications application specifically by means of an antenna 520 with a corresponding read or, as the case may be, write device accommodated to reading or, as the case may be, writing information stored in the radio transponder's memory. The inventive radio transponder 500 is coupled by means of an interface 510 to the interface 410 of the electronic control circuitry so that signals can be transmitted from the radio transponder 500 to the electronic control circuitry 400 of the display unit 1.

With regard to the exemplary embodiment an advantageous combination of barcode and radio transponder 500 can be implemented as an exemplary application. On the one hand information can be radio-readably stored in the memory of the radio transponder 500; on the other hand, the coupling of the radio transponder 500 and the display unit 1 enables a barcode to be imaged reproducing in encoded form at least a part of the information stored in the radio transponder 500. Either the electronic control circuitry 400 or the electronic circuitry of the radio transponder 500 advantageously includes for said purpose a component that will encode the barcode image in accordance with the desired symbology. Said component could furthermore support a multiplicity of symbologies that may be employed optionally.

The electronic control circuitry is preferably based on organic circuitry, polymeric circuitry or, as the case may be, circuits consisting of organic or polymeric components. Organic or polymeric circuitry and circuits are economical to produce and flexibly embodiable, which is of interest particularly in combination with a flexible display unit 1.

The electronic control circuitry 400 can furthermore be advantageously integrated vertically in the display unit 1, which is to say arranged vertically with respect to the imaging surface of the display unit 1. The electronic circuitry of the radio transponder 500 can furthermore, also preferably, be provided likewise in an integrated manner so that the components shown in FIG. 3 can be located in a common housing. A vertical integration is particularly advantageous therein.

1. Programmable display unit for displaying barcodes, comprising:
a multiplicity of strip-shaped display elements (110, 130) arranged substantially parallel to and at a predetermined distance (120) from each other;
wherein each strip-shaped display element (110, 130) can be controlled in a connectable manner;
wherein respectively predetermined numbers of display elements (110, 130) are used for representing strips (5, 6) or, as the case may be, spaces (7, 8) in the barcode.

2. Display unit according to claim 1 wherein in each case one group of a predetermined number of strip-shaped display elements (110, 130) are switched in common for each strip (5, 6) or, as the case may be, for each space (7, 8) in the barcode.

3. Display unit according to claim 1 wherein the strip-shaped display elements (110, 130) have at least two switchable statuses, with one of said statuses being assignable to a strip (5, 6) and the other of said statuses being assignable to a space (7, 8).

4. Display unit according to claim 1 wherein the display unit (1) is a meta-stable display unit (1) embodied in particular as an electrochromic or electrophoretic display unit (1).

5. Display unit according to claim 1 wherein electronic control circuitry (400) having an interface (410) is provided for controlling the strip-shaped display elements (110, 130).

6. Display unit according to claim 5 wherein the electronic control circuitry (400) has an interface (410) suitable for receiving signals causing a barcode to be produced.

7. Display unit according to claim 5 wherein the electronic control circuitry (400) is based on organic circuits.

8. Display unit according to claim 1 wherein the display unit (1) is coupled to a radio transponder (500).

9. Radio transponder having a display unit for displaying barcodes, with said radio transponder (500) being coupled to the display unit (1) for imaging the barcodes; wherein said display unit (1) comprises:
a multiplicity of strip-shaped display elements (110, 130) arranged substantially parallel to and at a predetermined distance (120) from each other; wherein each strip-shaped display element can be controlled in a connectable manner;
wherein respectively predetermined numbers of display elements (110, 130) are used for representing strips (5, 6) or, as the case may be, spaces (7, 8) in the barcode.

10. A radio transponder comprising the display unit according to claim 6.

11. Display unit according to claim 2 wherein the strip-shaped display elements (110, 130) have at least two switchable statuses, with one of said statuses being assignable to a strip (5, 6) and the other of said statuses being assignable to a space (7, 8).

12. Display unit according to claim 2 wherein the display unit (1) is a meta-stable display unit (1) embodied in particular as an electrochromic or electrophoretic display unit (1).

13. Display unit according to claim 3 wherein the display unit (1) is a meta-stable display unit (1) embodied in particular as an electrochromic or electrophoretic display unit (1).

14. Display unit according to claim 2 wherein electronic control circuitry (400) having an interface (410) is provided for controlling the strip-shaped display elements (110, 130).

15. Display unit according to claim 3 wherein electronic control circuitry (400) having an interface (410) is provided for controlling the strip-shaped display elements (110, 130).

16. Display unit according to claim 4 wherein electronic control circuitry (400) having an interface (410) is provided for controlling the strip-shaped display elements (110, 130).

17. Display unit according to claim 6 wherein the electronic control circuitry (400) is based on organic circuits.

18. Display unit according to claim 2 wherein the display unit (1) is coupled to a radio transponder (500).

19. Display unit according to claim 3 wherein the display unit (1) is coupled to a radio transponder (500).

20. Display unit according to claim 4 wherein the display unit (1) is coupled to a radio transponder (500).
